(19) United States
(12) Patent Application Publication
(10) Pub. No.: US 2024/0388678 A1
(43) Pub. Date: Nov. 21, 2024

(54) PROJECTOR

(71) Applicants: Khalil ARAFAT, London, Greater London (GB); Kristina ZELENKOVAITE, London, Greater London (GB)

(72) Inventors: Khalil ARAFAT, London, Greater London (GB); Kristina ZELENKOVAITE, London, Greater London (GB)

(21) Appl. No.: 18/718,026

(22) PCT Filed: Nov. 24, 2022
(86) PCT No.: PCT/GB2022/052972

§ 371 Date: Jun. 8, 2024

(30) Foreign Application Priority Data
Dec. 9, 2021 (GB) 2117839.7

(51) Int. Cl. H04N 9/31; G10L 13/02

(52) U.S. Cl. CPC H04N 9/31; G10L 13/02

(57) ABSTRACT

A projector (2) comprises an output unit (4) for delivering visual or audiovisual content; at least one movement sensor (24) or audio sensor (22); and a controller (20) in communication with the output unit (4) and the at least one sensor (22, 24). The controller (20) is configured to adjust an output level of the output unit (4) based on a signal from the at least one sensor (22, 24).

### FIELD OF THE INVENTION

The present invention relates to a projector. More particularly, but not exclusively, this invention relates to a projector of the type which may be used to sooth a child to sleep.

### BACKGROUND OF THE INVENTION

There are many products currently on the market which aim to sooth a baby or young child to sleep, thereby reducing the burden placed on the child's parents to stay with the child until they fall asleep. Such products include automated mobiles and soft toys which play music, and projectors which project a still image such as a stylised night sky, in some cases moving or rotating the image in order to be more engaging for the child. One problem with such products is that the extent to which they can engage a child is limited. A music-playing teddy bear or projected image of stars, for example is only likely to sooth a child (after the novelty value has worn off) if the child forms an emotional attachment to that product.

Video projectors, for instance those which can be connected to a computer, are also available. These are not limited to displaying specific content and can therefore be much more engaging. However, such projectors are generally intended to be used by adults or older children, in place of television sets, computer monitors and the like. They therefore generally output light at too high a level (and/or sound at too high a volume) to be suitable for soothing a child to sleep. Further, they are generally not suitable to be used in the room with an unsupervised child because the child may be able to approach the projector and look directly at the focused high-intensity light being produced, or the projector may be knocked by another person such that it shines that light at the child. This could be distressing or even damage the child's eyes.

It is an object of the invention to mitigate or obviate one of the aforesaid disadvantages, or to provide an improved or alternative projector.

### SUMMARY OF THE INVENTION

According to a first aspect of the present invention there is provided a projector comprising:
an output unit for delivering visual or audiovisual content;
at least one movement sensor or audio sensor; and
a controller in communication with the output unit and the at least one sensor, the controller being configured to adjust an output level of the output unit based on a signal from the at least one sensor.

The controller adjusting an output level of the output unit based on a signal from the movement sensor or audio sensor can allow the projector to adapt to perceived changes in the circumstances around it, for instance automatically reducing brightness or volume if a child near to the projector is believed to be asleep, and/or increasing if the child is believed to have woken up.

The projector may be a child-soothing projector or a night-time calming projector.

The controller may be in communication with a movement sensor which comprises a gyroscope. Instead or as well, the controller may be in communication with a movement sensor which comprises an accelerometer. In embodiments where the controller is in communication with a movement sensor which comprises both a gyroscope and an accelerometer, the movement sensor may be an IMU.

The controller may be configured to reduce said output level based on said signal.

For instance, the controller may be configured to reduce the output level to substantially zero based on said signal.

The signal may be indicative of a reduced or reducing level of activity of a person.

One advantage of the controller reducing the output level based on the signal is that the projector can become less intrusive if deemed appropriate based on the signal (which may for instance indicate that a nearby child is asleep, as noted above).

Instead or as well, the controller reducing the output level based on the signal may reduce the risk of the output of the projector causing distress or even injury to a child. For instance the controller may reduce the output level when the signal indicates that a child has approached or disturbed the projector, or that the projector has been knocked by a third party in a manner that might direct light in an unwanted direction, thereby reducing the extent to which that child can be dazzled by, or even have their eyes damaged by, light output from the projector.

The controller may be configured to increase said output level based on said signal.

For instance, the controller may be configured to increase the output level from substantially zero (for instance with the projector in a stand-by condition) based on said signal.

The signal may be indicative of an increased or increasing level of activity of a person.

One advantage of the controller increasing the output level based on the signal is that the projector can ‘wake up’ if deemed appropriate by the controller based on the signal (which may for instance indicate that a nearby child has woken up and may therefore wish to be entertained by the projector, or may indicate that a child has stopped approaching or disturbing the projector).

The projector may, for example, be configured to commence output at a first level and the controller may be configured to reduce the output to a second lower level in response to one signal from said sensor, and to subsequently raise the output to the first level again in response to another signal from the sensor.

The controller may further be configured to change the content delivered by the output unit in response to said signal, as well as adjusting the output level.

The controller being able to change the content delivered, as well as the level at which it is delivered, can further improve the ability of the projector to tailor its behaviour according to its perception of the surrounding environment.

The change to the content may include a change to the nature of the content. For instance, the projector may switch from one animation to a different animation (as well as adjusting e.g. the brightness at which the animation is projected). As another example, the projector may switch from an animation moving at a first speed to the same animation sped up or slowed down to a second speed.

The change to the content may include a change to the duration for which content is displayed. For example the projector may play an animation or video clip on repeat for a first duration (e.g. 20 minutes) before stopping playback, and in response to the signal the projector may play said animation/video for a shorter duration (e.g. 5 minutes) or a longer duration (e.g. 30 minutes).

The change to the content may include a change to the type of output provided by the output unit. For instance the projector may first output both light (e.g. video/animation) and sound but in response to the signal the controller may change the output to only light or to only sound, or vice versa. As another example the controller may switch the output of the output unit from only light to only sound, or vice versa, in response to the signal.

The controller may be configured to categorise different signals from said at least one sensor, indicative of different circumstances, into different categories and to react to different signals according to the category assigned to them.

This can allow the projector to tailor its actions more effectively to the perceived circumstances, in comparison to an arrangement where the controller treated all signals as being indicative of a single circumstance.

Nonetheless, the invention may be utilised with all signals being reacted to in the same way. That may be beneficial in terms of simplicity (and therefore cost) of the projector. Instead or as well, where the controller adjusts the output level for safety reasons (e.g. so as to avoid eye damage from light output) it may be beneficial for the controller to respond to all signals as being indicative of a child approaching/disturbing the projector so as to be “better safe than sorry”.

The controller may be configured to categorise some signals as being indicative of a person sleeping.

The controller may be configured to reduce the output level of the output unit in response to a signal categorised as being indicative of a person sleeping.

Signals indicative of a person (e.g. a child) sleeping may include, for example, the sound of snoring or reduced vibration resulting from the person lying more still.

The projector being able to identify when a person is sleeping can allow it to take steps (for instance reducing output level and/or changing the content to something less stimulating) to reduce the chances of the output inadvertently waking the person up.

The controller may be configured to categorise some signals as being indicative of a person being awake.

The controller may be configured to increase the output level of the output unit in response to a signal categorised as being indicative of a person being awake.

Signals indicative of a person (e.g. a child) being awake may include, for example, the noise and/or vibrations from coughing or sneezing, the sound of a change in breathing rate and/or the vibrations from increased level of movement.

The projector being able to identify when a child is awake can allow it to take steps (for instance increasing the output level and/or changing the content) to engage a child more effectively and thereby reduce the need for parental intervention to get the child back to sleep.

The controller may be configured to categorise some signals as being indicative of a person being in distress.

The controller may be configured to reduce the output level of the output unit in response to a signal categorised as being indicative of a person being in distress.

Signals indicative of a person (e.g. a child) being in distress may include, for example, the sound or vibrations of severe crying, persistent coughing, attempting to get out of a cot or bed and/or (in the case of older children) calling out for a parent.

The projector being able to identify when a child is in distress can allow it to take steps (for instance reducing output level or stopping output altogether) to reduce the chances of the output of the projector preventing a parent from hearing or seeing that their child is in distress.

The controller may be configured to categorise some signals as being indicative of the projector being disturbed.

The controller may be configured to reduce the output level of the output unit in response to a signal categorised as being indicative of the projector being disturbed.

Signals indicative of the projector being disturbed may include, for example, the sound of or the vibrations resulting from something (or someone) impacting the projector, or a change in orientation of the projector detected by the movement sensor.

The projector being able to identify when it has been disturbed can reduce the risk of light output therefrom being accidentally shone into a person's eyes.

The controller may be configured to categorise some signals as false alarms.

The controller may be configured to make no change to the output level of the output unit in response to a signal categorised as a false alarm.

Such a ‘false alarm’ signal may be, for example, the sound or vibrations of footsteps and/or the opening/closing of a door (which may indicate that a parent has come into the room to check on their child and may therefore warrant no change in the behaviour of the projector), and/or other signals indicative of normal domestic life such as the sound of a pet barking or the light from passing car headlights.

Some signals being categorised as false alarms can reduce the risk of the controller adjusting the output level erroneously (for instance the controller receiving a signal indicative of a lorry passing close by and interpreting it as being indicative of a child waking, whereupon it could increase the output level and in doing so increase the chances of the child being disturbed from sleep).

The controller may further be configured to gradually reduce the output level of the output device in accordance with an internal timer.

The output level being gradually reduced can allow the output of the projector to ‘fade out’ as a person falls asleep. This can make the reduction in output level less perceivable to a person, and thus less disruptive to the process of falling asleep. In contrast, a sudden reduction in output level may be noticed by the subconscious of a person in the process of falling asleep or in a light stage of sleep, rousing them back to wakefulness.

The gradual reduction in output level may be prompted by the controller in response to a signal (for instance a signal indicative that a person is asleep), or the gradual reduction may be separate functionality to any adjustments made by the controller in response to a signal from a movement sensor or audio sensor.

According to a second aspect of the present invention there is provided a projector comprising an output unit for delivering visual or audiovisual content, and a controller in communication with the output unit, the controller being configured to gradually reduce an output level of the output device in accordance with an internal timer.

As noted above, a projector gradually reducing an output level can allow the output of the projector to ‘fade out’ as a person falls asleep, reducing the risk of them being woken up by the projector.

Said output level may comprise a brightness of a light output of the output device.

Said output level may comprise a volume of a sound output of the output device.

The controller may be configured to gradually reduce both brightness and volume to substantially zero, with brightness and volume reaching substantially zero at different points in time.

The controller may be configured to reduce the brightness and volume such that the brightness reaches substantially zero before the volume. As an alternative, the controller may be configured to reduce the brightness and volume such that the volume reaches substantially zero before the brightness.

The controller making brightness and volume reach substantially zero at different times may make the overall reduction in the influence of the projector on a child even more gradual, in contrast to both light and sound levels stopping at the same point. For instance, a child in the early stages of sleep may become aware that sound from the projector has stopped, open their eyes and see video or animation, feel reassured that they are not alone, and return to sleep. Conversely, the gradual reduction in projection brightness may help the child to close their eyes, with the sound from the projector reassuring them until they are asleep.

The projector may be configured to transition from a powered-off state to a playback state in which entertainment content is outputted, in response to a single input from a user.

This can allow a parent to start the projector advantageously easily, thereby reducing the risk of a child becoming restless in the time taken by a parent to start the projector (as may happen if the parent must scroll through menus and the like before playback can start)

The single input from the user may be, for example, pressing a button, pressing and holding a button or double-clicking a button.

The single input from the user may be an input applied to two buttons, for instance the single input may be pressing two buttons simultaneously, pressing and holding two buttons simultaneously, or pressing one button while holding another button down.

The use of two buttons can reduce the risk of a parent accidentally putting the projector into the playback state, for instance while moving the projector.

Where the single input is an input applied to two buttons, the projector may be configured such that when in said playback state, subsequent presses of said button (or one of said buttons) cycles through different entertainment content options.

This can improve the ease with which a parent can change which content they would like the projector to output, thereby reducing the overall delay or disruption caused by setting the projector.

The projector may be configured to collect health data from a nearby person during use.

The health data collected by the projector may include data on the sleep schedule and/or sleep pattern of the person. Instead or as well, it may collect data concerning how frequently the person sneezes and/or coughs, for example. Such data may be determined by feedback from the audio sensor and/or movement sensor, or from a separate sensor.

The projector collecting data can allow a parent to check on the wellbeing of their child (for instance checking they stay in bed and/or checking that they get sufficient sleep while in bed) without needing separate equipment such as a smartwatch.

The projector may comprise a data memory configured to store the data collected by the projector. This can avoid the need for the projector to transmit the data in real time as it is collected.

The projector may further comprise a wireless communication transmitter.

For example, the projector may comprise a Bluetooth or WiFi communications chip. This can allow the projector to function as a baby monitor. The projector may, for instance, transmit all sounds detected by its audio sensor so that they can be played by a receiving device such as a mobile phone. As an alternative, the projector (for instance the controller of the projector) may be configured to filter the sound detected by the audio sensor so as to filter out one or more sounds caused by the projector itself (e.g. the audible part of the content being output by the projector, and/or the noise of a cooling fan of the projector). Instead or as well, the projector may transmit only sounds in one or more specific categories (such as those categorised as being indicative that a child is awake). As a further example, the projector may not transmit sounds but may instead transmit more general data such as traffic light indicators summarising whether signals from the movement sensor and/or audio sensor suggest that a nearby child is asleep, awake but content, or awake and in distress.

The projector may further comprise a camera.

The camera may, for example, be used in conjunction with a wireless transmitter so that the projector can function as a photo-enabled or video-enabled baby monitor. Instead or as well, information from the camera may be used by the controller, in conjunction with one or more signals from the movement sensor/audio sensor, so as to determine if the output level should be adjusted.

The projector may further comprise an onboard battery arranged to power the output device, and an onboard playback memory, the playback memory being configured to store playback content to be outputted by the output device.

Such a protector may be able to function without connection to a power-source and without communicating with a separate storage device on which sound/video files are stored for playback, thereby allowing the projector to be used in a wider range of locations.

The projector may further comprise a base defining a plane of contact for engaging a surface on which the projector is rested, wherein the output unit is configured to emit light at an angle of between 20 and 70 degrees, for instance between 30 and 60 degrees or between 40 and 50 degrees, to the plane of contact.

The base may be a planar surface which corresponds to the plane of contact. As an alternative, the base may have a set of projections such as feet, the tips of which define the plane of contact.

The controller may be configured to synchronise a sound file with a set of sound effect files, picture files and/or video files so as to play an audiobook with accompanying sound effects, pictures and/or animations.

The projector can therefore essentially ‘read a book’ to a child without requiring input from a parent.

The controller may be configured for communication with a voice synthesis unit, the voice synthesis unit being configured to generate an artificial rendering of spoken word.

For example, the voice synthesis unit may be configured to retrieve a voice ID from a voice ID memory and modify a base file according to the voice ID so as to synthesise said sound file, the sound file taking the form of said artificial rendering of spoken word.

One example of generation of artificial renderings of spoken word can be generated is the ‘Overdub’ AI software available from the ‘Lyrebird’ division of Descript, Inc. Participants record a short sample of their speech, from which the software creates a voice ID model. That model can then be used in conjunction with text-to-speech software to read any required text aloud in a ‘clone’ of the participant's voice. More detail is available at www.descript.com/overdub.

The projector can therefore ‘read a book’ to the child in a voice which resembles one they recognise (that of one of the child's parents, for example).

The voice synthesis unit may be provided within the projector, or may be provided externally to the projector (for instance in a mobile phone which may communicate with the controller of the projector via a wired or wireless connection). Similarly, the voice ID may be stored within a memory of the projector or may be stored externally, and the base file may be stored within a memory of the projector or may be stored externally.

According to a third aspect of the present invention there is provided a projector arranged to generate light output or to generate sound and light output, the projector being configured to automatically change the amount of sound and/or light output in response to feedback from one or more sensors, the projector further being configured to automatically reduce the amount of sound and/or light output progressively over a duration determined by an internal clock.

The projector may be a stand-alone unit. As an alternative, it may be part of a larger multifunctional appliance. In a fourth aspect of the present invention there is provided a mobile telephone comprising a projector according to the first or second aspect of the invention. Such a mobile phone may provide the functionality discussed above, in conjunction with the functionality generally provided by a mobile phone, thereby eliminating the need for two separate devices.

For the avoidance of doubt, reference herein to a child is not intended to be limiting. It is to be understood that a projector may also be used by, or designed to be used by, people of any age.

### DESCRIPTION OF THE DRAWINGS

Embodiments of the present invention will now be described by way of example only with reference to the accompanying schematic drawings in which:

FIG. 1 is a schematic view of a projector according to an embodiment of the invention;

FIG. 2 is a side view of the projector of FIG. 1 in use, projecting an image above a cot; and

FIG. 3 is a side view of the projector of FIGS. 1 and 2, in communication with a voice synthesis unit of a mobile phone.

### DETAILED DESCRIPTION

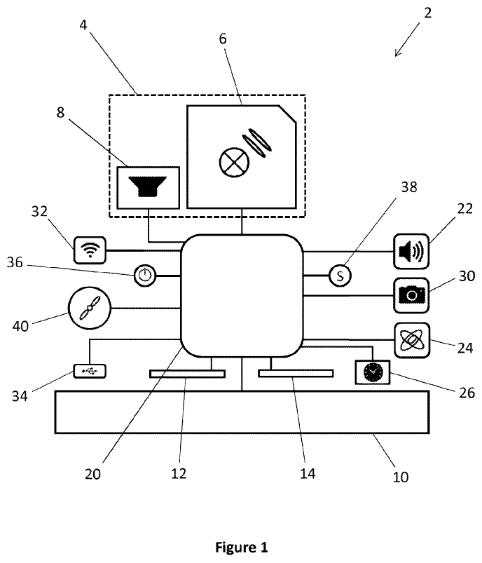

FIG. 1 is a schematic representation of a projector 2 according to an embodiment of the invention. It has an output unit 4 which comprises a projection assembly 6 that comprises a light source and focusing lenses (not visible) for projecting still or moving pictures, and a speaker assembly 8 for outputting sound. The projector 2 further includes an onboard battery 10 configured to power the projector 2, an onboard content memory 12 for storing content to be played by the projector, and an onboard data memory 14 for storing data collected by the projector 2 as discussed below.

The function of the projector 2 is managed by a controller 20 which is connected to the output unit 4, battery 10, content memory 12 and data memory 14. When the projector is in use, the controller 20 takes power from the battery 10 and retrieves from the memory 12 a data file corresponding to particular content to be outputted by the projector, and supplies both power and data to the output unit 4. The projection assembly 6 provides light output and/or the speaker assembly 8 provides sound output, according to the file retrieved from the memory 12, so as to produce the desired content such as a video animation with accompanying sound effects.

The controller 20 is also connected to an audio sensor 22 in the form of a microphone, a movement sensor 24 in the form of an IMU with gyroscope and accelerometer, and a timer unit 26. The controller 20 can vary the output level of the output unit 4, i.e. the brightness of light produced by the projection assembly 6 and/or the volume of sound produced by the speaker assembly 8, according to signals from the audio sensor 22, movement sensor 24 and/or timer unit 26. This is described in more detail below.

The projector 2 also has a camera 30, a WiFi communications chip 32 (which is an example of a “wireless communication transmitter”), a USB port 34, a power button 36, a safety button 38, and a fan 40, each of which is connected to the controller 20. The controller can communicate with an external device such as a laptop computer or mobile phone (for instance supporting a linked application or website on which the projector 2 is registered), either wirelessly via the WiFi communications chip 32 or through wired connection via the USB port. This communication can allow control of the projector 2, for instance setting user preference options, selecting content to be played at next operation and/or uploading new content into the content memory 12. It can also allow firmware updates of the projector 2 to be installed. It can also allow an external device to access data collected by the projector 2, for instance data stored in the data memory 14, as described below.

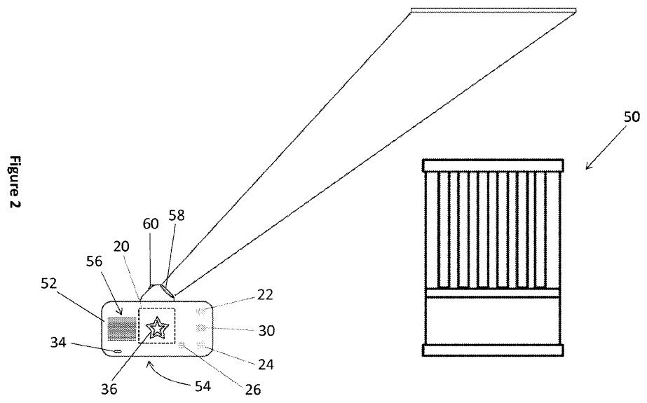

FIG. 2 shows the projector 2 in use, being used to output content to lull to sleep an infant in a cot 50. In this case the content takes the form of a lullaby played through the speaker assembly 8 in conjunction with a video of cartoon sheep jumping over a fence, projected onto the ceiling above the cot 50 by the projection assembly 6.

Visible in FIG. 2 is an outer case 52 of the projector 2, which has a planar base 54 defining a plane of contact for resting on a floor or a table or the like, and a vent 56 through which air can be sucked into the case 52 by the fan 40 to cool the projector (in particular the projection assembly 6). Also visible in FIG. 2 is an outer lens 58 and focus knob 60 of the projection assembly 6. The power button 36, which in this case is star shaped, is also visible in FIG. 2. The safety button 38 is provided in a corresponding location on the opposite side of the projector 2 to the side visible in FIG. 2, as is a vent for exhausting cooling air from the case 52.

It is noteworthy that in this embodiment the projection assembly 6 is arranged to emit light at around 45 degrees to the plane of contact defined by the base 54 (i.e. around 45 degrees to the plane of the base, in this case). Accordingly, with the base 54 placed on a horizontal surface the light is emitted at an angle of around 45 degrees to the horizontal. This is in contrast to most projectors where light is emitted either parallel to the base (i.e. in a forward direction) or perpendicular to the base (i.e. straight upwards). The light being emitted at this intermediate angle can allow the projector 2 to be placed on a surface to one side of the cot 50 and project onto the ceiling above the cot 50. In contrast, if the light were emitted at too great and angle to the base 54 then to project onto the ceiling above the cot 50 the projector would have to be placed very close to the cot 50, whereupon a child in the cot 50 may be able to look into the projector and have high intensity light shone into their eyes. Conversely if the light were emitted at too small an angle to the base, to project onto the ceiling above the cot 50 the projector would need to be placed far away from the cot 50, which may not be practical in a normal sized room.

The projector 2 emitting light at this intermediate angle can also simplify the process of keystone adjustment, which may be pre-set so that manual adjustment is not required. In contrast, a projector which projects light straight upwards or straight forwards would not only need to be rigged up to project above the cot in this manner, but would also need considerable keystone adjustment (since such projectors are generally set up to project light onto a surface perpendicular to the direction in which the light is projected).

The projector 2 is designed to be turned on, i.e. moved from a powered-off state to a playback state in which entertainment content (rather than merely content in the form of a selection menu or the like) is being outputted, with advantageous ease. In this embodiment the projector 2 can be moved from the powered-off state to the playback state in response to a single action from a user (e.g. a parent). To turn the projector 2 on, a parent need only hold down the safety button 38 and the power button 36 for a period of two seconds. The projector 2 will then power up and begin playing a default piece of content (in this case the lullaby with sheep animation discussed above). With the projector 2 turned on, the content being outputted can be changed simply by pressing the power button 36 to cycle through available content options. In this case a first subsequent press of the power button 36 selects content in the form of a second lullaby with an animated night sky scene, a further press of the power button 36 selects content in the form of birdsong accompanied by slowly shifting abstract coloured patterns, and an additional press of the power button selects content in the form of classical music accompanied by kaleidoscope-like displays of coloured shapes. Subsequent presses of the power button 36 iteratively cycle through the above options in a continuous loop.

As noted above, the controller 20 is connected to an audio sensor 22 and a camera 30. The controller passes signals received from the audio sensor 22 and camera 30 to the WiFi communications chip, which in turn broadcasts them to a paired device such as a mobile phone. The projector 2 can therefore function as a baby monitor, in this case a video-enabled baby monitor, allowing a parent to keep an eye on their child using the camera 30, and listen to any noises their child makes using the audio sensor 22. In this case the controller 20 has an integral signal filter. This removes, from the signal from the audio sensor 22, any noise determined to be part of the content that the projector 2 is outputting before the signal is sent to the WiFi communications chip 32 for broadcast. Accordingly the parent can hear any noises made by their child but does not hear the content being output by the projector 2. This can avoid the risk of the content annoying the parent, or making noises made by the child harder for the parent to hear.

Also as noted above, the controller 20 is connected to a timer unit 26. The controller 20 gradually reduces the output level of the output unit 4 in accordance with the timer. More particularly, in this embodiment when the projector 2 is powered on as above, the timer unit 26 starts timing a period of 20 minutes. Over the course of that 20 minutes (unless interrupted as discussed below), the controller gradually dims the light output of the projection assembly 6 and lowers the volume of the sound output from the speaker assembly 8 to zero (i.e. complete darkness and complete silence). The gradual reduction in light and volume follow linear paths (in terms of user perception, rather than absolute power output), but the controller 20 reduces the brightness of output from the projection assembly 6 more quickly than it reduces the volume of output from the speaker assembly 8. Thus the light output reaches zero after 18 minutes whereas the sound output reaches zero after 20 minutes.

After the 20 minute period has elapsed, the projector 2 enters a standby state where neither the projection assembly 6 nor the speaker assembly 8 operate, but the controller still receives power from the battery 10 and continues to receive signals from the audio sensor 22, movement sensor 24 and camera 30. The projector 2 can therefore continue to operate as a video-enabled baby monitor, and can still vary the output levels of the output unit 4 based on those signals as mentioned above.

The controller 20 of the projector 2 of this embodiment can adjust the output levels of the output unit 4 in numerous different ways, depending on the nature of the signals received. More particularly, the controller 20 categorises signals from the audio sensor 22, movement sensor 24 and camera 30 as being (a) indicative of a person (i.e. the child in the cot 50) sleeping, (b) being indicative of the person being awake, (c) being indicative of the person being in distress, (d) being indicative of the projector 2 being disturbed, and (e) being false alarms.

The controller 20 of the projector 2 of this embodiment adjusts both output levels (i.e. brightness and volume) of the output unit 4 if it receives a signal from the audio sensor 22, movement sensor 24 and/or camera 30 that it categorises as being indicative of the child being awake. Such signals may include the audio sensor 22 sensing the sound of a cough or a sneeze, and/or the camera 30 detecting that the child has sat up or stood up. In response to such a signal, the controller 20 restarts playback, thereby increasing the output levels of the projection assembly 6 and speaker assembly 8.

In such a case the controller 20 restarts playback (i.e. adjusts the output levels upwards from zero), in the hope of soothing the child back to sleep, but in this embodiment it does not restart playback at the same brightness or volume as when the projector 2 was first turned on. When the projector 2 is first turned on, its content is outputted at a first volume and a first brightness, whereas when the controller 20 restarts playback after receiving a signal indicative of the child being awake, the playback is restarted at a second volume and second brightness. In this particular case, the second volume is 75% of the first volume and the second brightness is 50% of the first brightness. In this way, the projector 2 restarts playback so as to sooth the child back to sleep, but the reduced output levels reduce the risk that the child will be stimulated to a state of greater alertness, rather than being soothed back to sleep, by the content outputted by the projector 2.

Furthermore, in this case the controller also changes the content outputted, as well as the output levels. Specifically, where previously the content was played on a loop for 20 minutes with gradually diminishing output levels, after restarting due to the controller receiving a signal indicative of the child being awake the content is played on a loop for 10 minutes, again with gradually diminishing output levels.

The controller 20 also adjusts both output levels based on a signal from the audio sensor 22, movement sensor 24 and/or camera 30 indicative that the child is asleep. Such a signal may be, for example, the audio sensor 22 detecting a noise perceived to be snoring, or the camera noting minimal movement of the child for a predetermined period. Upon receipt of such a signal, the controller 20 adjusts both brightness of the projection assembly 6 and volume of the speaker assembly 8 downwards to zero. In this specific case the controller 20 adjusts those output levels gradually over the space of, for example, one minute (timed by the timer unit 26, for instance). The chance of the content waking the child is therefore reduced. After the output levels reach zero, the projector 2 enters the stand-by mode.

The controller 20 also adjusts both output levels in response to a signal indicative of the child being in distress. Such a signal may be, for example, the audio sensor 22 detecting the sound of the child crying at a tone and/or volume outside of normal levels for a child who is not in need of parental intervention, or the movement sensor 24 detecting vibrations caused by the child insistently kicking their legs. Upon receipt of such a signal the controller 20 reduces both output levels to zero instantaneously, thereby increasing the chance of a parent hearing or seeing their child's distress (or indeed noticing the sudden cessation of playback), either directly or thanks to the baby monitor function of the projector 2.

Furthermore, the controller 20 adjusts both brightness and volume if it receives a signal categorised as being indicative of the projector 2 being disturbed, for instance knocked over by a parent or picked up by the child. Such a signal may for instance be an impact shock or a change in orientation detected by the movement sensor 24. In response, the controller 20 reduces both output levels to zero instantaneously. This can avoid the possibility of the light output from the projection assembly 6 dazzling the child or even damaging their eyes, and the sudden drop in volume (audible directly or thanks to the projector's baby monitor function) can help to alert a parent that the projector 2 has been disturbed.

In this particular embodiment, after the controller 20 adjusts the output levels in response to a signal indicative of the child being asleep, the projector 2 enters the standby mode (from which it will reactivate if the controller 20 receives a signal indicative of the child being awake again, and in which it continues to function as a baby monitor). If the controller 20 adjusts the output levels in response to a signal indicative that the child is in distress or that the projector has been disturbed, however, the projector 2 enters a safety mode from which it will not recommence playback regardless of what other signals the controller 20 subsequently receives from the audio sensor 22, movement sensor 24 and camera 30 (but will still function as a baby monitor). The projector 2 can only be restarted from the safety mode by turning it off and on again. This can reduce the risk that the projector 2 restarts while the child is still in distress or while the projector 2 is not correctly positioned, due to a signal being incorrectly categorised as being indicative of the child being asleep.

As noted above, the controller 20 also categorises some signals as false alarms. Such signals may include the movement sensor 24 detecting vibrations originating from a lorry passing outside or from an adult walking across the room to check on the child, the audio sensor 22 detecting the sound of conversation in an adjacent room, or the camera 30 detecting a pet walking past. In this embodiment the controller 20 makes no adjustment to any output level in response to a signal categorised as a false alarm. Indeed, the controller 20 makes no change of any kind in response to a false alarm signal.

The projector 2 can also collect health data relating to the child. More particularly, it can be set to log when the child is believed to be asleep and to store that information in the data memory 14. A parent can then access that information, for instance via the USB port 34 or the WiFi communications chip 32 so as to learn information such as how long the child usually takes to fall asleep, how often they wake during the night, etc.

In addition to the content described above, the projector 2 is also able to ‘read a book’ to the child. The controller 20 can retrieve a sound file of the book in question being read, and a separate set of files such as picture files, video files and/or sound effect files, combining them such that the output comprises the audio file of the book being read in combination with one or more sound effects, illustrations or animated illustrations that are synchronised with the events being described in the sound file. For example, the sound file may be the story of Peter Pan and the controller 20 may synchronise with that playback a set of illustrations of key scenes in the book, and sound effects representing the sprinkling of fairy dust, the clash of swords and the like.

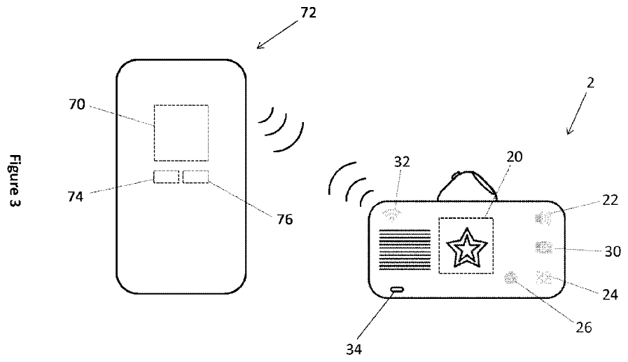

As shown in FIG. 3, in this embodiment the controller 20 can communicate via WiFi communications chip 32 (or alternatively via USB port 34) with a voice synthesis unit 70 comprised within a mobile phone 72. The mobile phone 72 also has a voice ID memory 74 and a base file memory 76. The mobile phone 72 can store voice IDs of particular speakers, for instance the child's parents and/or celebrity narrators, produced using samples of those people's voices. The voice synthesis unit then takes from the voice ID memory 74 the relevant the relevant voice ID, and takes from the base file memory 76 the relevant base file which contains the words of the story to be ‘read’, then modifies the base file to produce a sound file of those words being read in an artificial copy of the relevant person's voice. The sound file is then provided to the controller 20 of the projector 2, for output in combination with pictures, video and/or sound effects as described above. For example, the voice synthesis unit may retrieve the story of Peter Pan from the base file memory 76 and retrieve the voice ID of the child's mother, and then modify the base file to artificially render a sound file containing the mother ‘reading’ the story of Peter Pan, then send that sound file to the controller 20 to have sound effects and illustrations synchronised therewith.

Whilst the present invention has been described and illustrated with reference to particular embodiments, it will be appreciated by those of ordinary skill in the art that the invention lends itself to many different variations not specifically illustrated herein. By way of example, in another embodiment of the invention the voice synthesis unit and/or the voice ID memory and/or the base file memory may be included on the projector itself. Instead or as well, the projector may not be a stand-alone unit as is the case in the above embodiment, but may instead be a sub-assembly included within a mobile phone. As another example, whilst the above embodiment has been described with the timer unit being separate to the controller, in other embodiments the timer may be an integral part of the controller itself.

As another example, in other embodiments of the invention gradual reduction in an output level of the projector may take a different form to that described above. As one example, a controller may gradually reduce an output level over a period of 15 minutes, with the output level remaining constant for the first five minutes before then decreasing exponentially over the remaining ten minutes.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A projector comprising:
an output unit for delivering visual or audiovisual content;
at least one movement sensor or audio sensor; and
a controller in communication with the output unit and the at least one sensor, the controller being configured to adjust an output level of the output unit based on a signal from the at least one sensor;
wherein the controller is configured for communication with a voice synthesis unit, the voice synthesis unit being configured to generate an artificial rendering of spoken word; and wherein the voice synthesis unit is integrated in, or remote from, the projector.

2. A projector according to claim 1 wherein the controller is configured to reduce said output level based on said signal.

3. A projector according to claim 1 wherein the controller is configured to increase said output level based on said signal.

4. A projector according to claim 1, wherein the controller is further configured to change the content delivered by the output unit in response to said signal, as well as adjusting the output level.

5. A projector according to claim 1, wherein the controller is configured to categorise different signals from said at least one sensor, indicative of different circumstances, into different categories and to react to different signals according to the category assigned to them.

6. A projector according to claim 5 wherein the controller is configured to categorise some signals as being indicative of a person sleeping.

7. A projector according to claim 5 wherein the controller is configured to categorise some signals as being indicative of a person being awake.

8. A projector according to claim 5, wherein the controller is configured to categorise some signals as being indicative of a person being in distress.

9. A projector according to claim 5, wherein the controller is configured to categorise some signals as being indicative of the projector being disturbed.

10. A projector according to claim 5, wherein the controller is configured to categorise some signals as false alarms.

11. A projector according to claim 1, wherein the controller is further configured to gradually reduce the output level of the output device in accordance with an internal timer.

12. A projector comprising an output unit for delivering visual or audiovisual content, and a controller in communication with the output unit, the controller being configured to gradually reduce an output level of the output device in accordance with an internal timer.

13. A projector according to claim 1, wherein said output level comprises a brightness of a light output of the output device.

14. A projector according to claim 1, wherein said output level comprises a volume of a sound output of the output device.

15. A projector according to claim 14, wherein the controller is configured to gradually reduce both brightness and volume to substantially zero, with brightness and volume reaching substantially zero at different points in time.

16. A projector according to claim 1, wherein the projector is configured to transition from a powered-off state to a playback state in which entertainment content is outputted, in response to a single input from a user.

17. A projector according to claim 1, wherein the projector is configured to collect health data from a nearby person during use.

18. A projector according to claim 1, further comprising a wireless communication transmitter.

19. A projector according to claim 1, further comprising a camera.

20. A projector according to claim 1, further comprising an onboard battery arranged to power the output device, and an onboard playback memory, the playback memory being configured to store playback content to be outputted by the output device.

21. A projector according to claim 1, further comprising a base defining a plane of contact for engaging a surface on which the projector is rested, wherein the output unit is configured to emit light at an angle of between 30 and 60 degrees to the plane of contact.

22. A projector according to claim 1, wherein the controller is configured to synchronise a sound file with a set of sound effect files, picture files and/or video files so as to play an audiobook with accompanying sound effects, pictures and/or animations.

23. (canceled)

24. (canceled)

25. A mobile telephone comprising the projector according to claim 1.
